(19) United States
(12) Patent Application Publication
(10) Pub. No.: US 2002/0095458 A1
(43) Pub. Date: Jul. 18, 2002

(54) Method, system and computer program for enhanced access to content over a network

(76) Inventors: Daniel Silverstein, Bloomfield Hills, MI (US); Nathan Hunsperger, San Jose, CA (US); Bem Jones-Bey, Fremont, CA (US); Ken Singer, San Francisco, CA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/010,970

(22) Filed: Dec. 6, 2001

Related U.S. Application Data
(60) Provisional application No. 60/251,566, filed on Dec. 6, 2000.

(51) Int. Cl. G06F 15/16

(52) U.S. Cl. 709/203

(57) ABSTRACT

A method is provided for a first network resource to facilitate access of a client to content, comprising the steps of receiving from a user a request for a document stored at a second network resource; obtaining the requested document from the second network resource; determining whether the requested document contains instructions for redirecting to a document at a network resource other than the first network resource; replacing the instructions with an instruction to redirect to the first network resource, and providing the document to said user with the replaced instructions. The method may also include, in response to a request from a user, providing linked term content including terms selected from the document, and links associated with each of the terms.

### RELATED APPLICATIONS

This application claims priority from copending U.S. Provisional Patent Application Serial No. 60/251,566, filed Dec. 6, 2000, which application is hereby incorporated by reference herein in its entirety.

### FIELD OF THE INVENTION

This invention is in the field of computing, particularly networked computing, and in the field of making content available over the Internet from servers to client devices.

### BACKGROUND OF THE INVENTION

The world wide web has become an extremely valuable resource for millions of users. It provides access to billions of pages of information on every possible topic, and allows consumers to purchase items of almost any description from their desktops. Many users have become accustomed to the ease of obtaining real-time information and ordering products and services, and feel inconvenienced when they do not have access to a computer, or an available computer lacks access to the Internet.

Many manufacturers have created portable, wireless products that allow information to be transferred over the cellular and radio infrastructure, thus enabling the mobile user to access the world wide web. One such device is the wireless access protocol (WAP) enabled cellular telephone. These small, portable Internet capable devices have a variety of disadvantages when compared with desktop computers. The devices have limited screen real estate. Many screens are no more than 4 to 6 lines in length, and do not support color. Some screens do not support shades of gray. Also, the bandwidth available is much less than that available even from a conventional dial-up modem connection. As a result, simplified versions of the languages for websites, such as HDML and WML, have been developed to accommodate these deficiencies. Using these languages, providers have begun to allow users to engage in functions such as checking e-mail, trading securities, making travel reservations, and locating movie times and locations.

A further limitation of handheld devices such as cellular telephones are the limited user interfaces. The input method for WAP enabled cell phones assigns up to five different characters to a single key. The character is selected by tapping the key rapidly in succession. The letter “s” requires four taps, and the numeral “9” requires five taps. Entering standard punctuation marks requires accessing a menu, scrolling through screens of options, finding the correct symbol, and pressing the corresponding button. Such tasks as entering a uniform resource location, or web address, are so time-consuming as to be unacceptable to most users. Common tasks, such as entering text in a search engine, are similarly daunting.

The devices are also limited in processor speed and storage. Also, adding applications is difficult, if not impossible.

### SUMMARY OF THE INVENTION

In one aspect of the invention, a method is provided for a first network resource to facilitate access of a client to content, comprising the steps of: receiving from a user a request for a document stored at a second network resource; obtaining the requested document from the second network resource; determining whether the requested document contains instructions for redirecting to a document at a network resource other than said network resource; replacing the instructions with an instruction to redirect to the first network resource, and providing the document to the user with the replaced instructions.

In another aspect of the invention, a system is provided for enabling a first network resource to facilitate access of a client to content, comprising means for obtaining a requested document from a second network resource in response to a request from a client, determining whether the requested document contains instructions for redirecting to a document at a network resource other than said network resource, replacing instructions to obtain a document from a network resource other than said network resource with instructions to obtain a document from said network resource, and means for providing the document to the user with the replaced instructions.

In another aspect of the invention, a storage medium has stored thereon a computer program containing instructions, which, when executed by a processor, cause the processor to perform the steps of receiving from a user a request for a document stored at a second network resource; obtaining the requested document from the second network resource; determining whether the requested document contains instructions for redirecting to a document at a network resource other than said network resource; replacing the instructions with an instruction to redirect to said network resource, and providing said document to said user with said replaced instructions.

By the foregoing method, system and computer program, a user of a handheld device has the ability to obtain Internet-based services, including searching, without the need to enter text from limited or cumbersome keypads. The functionality is always available, as the user is always connected to the site providing the functionality. Additional advantages of the invention will be evident from the detailed description which follows.

### BRIEF DESCRIPTION OF THE FIGURES

FIG. 1 is a schematic diagram showing a system of the invention in its environment.

FIG. 2 is a schematic diagram showing major components of a system of the invention.

FIG. 3A, 3B and 3C is a flow diagram illustrating a method of the invention.

FIGS. 4A, 4B, 4C and 4D are illustrations of displays in a method of the invention.

### DETAILED DESCRIPTION

The invention includes a method and system for facilitating access to information over a network from a device connected to the network. A system and computer software are provided for facilitating the connection. The network may be the Internet. The system is particularly adapted for use with devices lacking a complete keyboard, such as cellular telephones and personal digital assistants. When a client device obtains a document, such as a page or card, from a server implementing the method of the invention, the server of the invention alters the page or card to facilitate routing of all subsequent document requests through the server of the invention. Documents from other servers on the network are provided to the client, but hyperlinks in those documents are rewritten to refer to the server of the invention. The method of the invention makes available to the client the option of accessing a dynamic page having links based on the content of the document furnished to the client. One or more terms from the document are furnished with associated instructions to link to related documents on the network. This facilitates scrolling through text, rather than having a need to type web addresses or search terms. There is no need to install additional software on the handheld device. The system of the invention may be characterized as similar in function to a transparent proxy, or to a persistent portal, although implemented in a different manner from either of those.

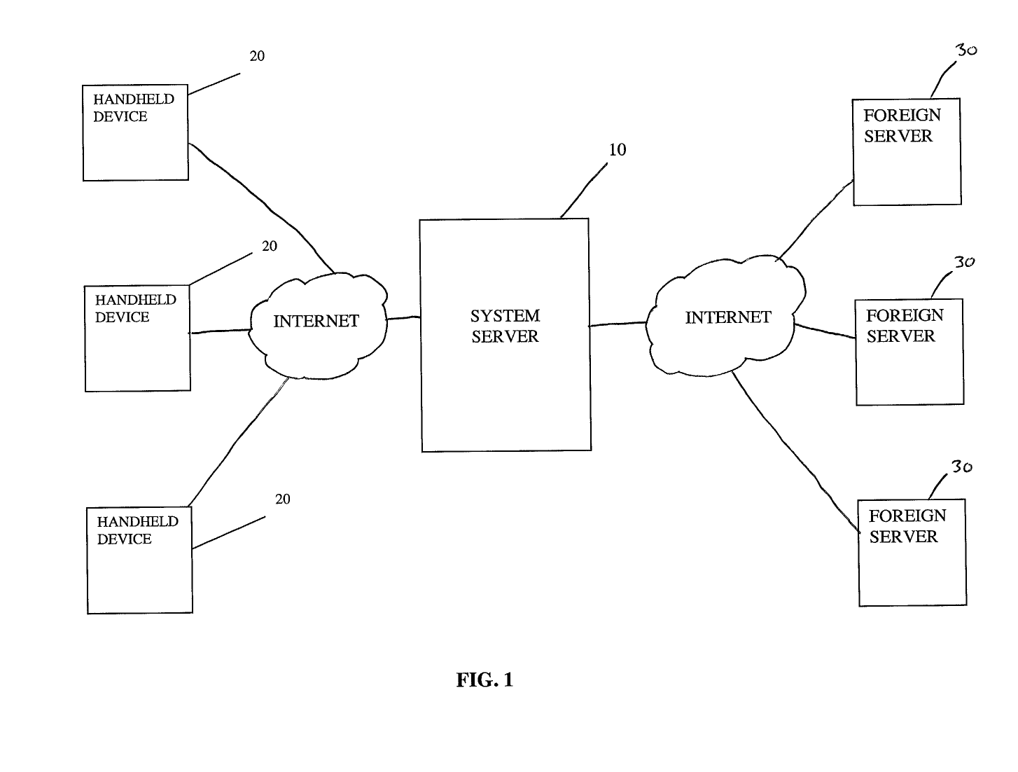

Referring now to FIG. 1, the context of a method and system according to the invention will be explained. Server 10 is an example of a system of the invention, which is running software which instructs it to carry out the method of the invention. Server 10 is a network server, such as a world wide web server. Server 10 has a processor, which may be an Intel Pentium processor, or other processor. Server 10 may be referred to as the system server or a first network resource. The server 10 may use a Unix operating system. Web serving software is running on the processor of server 10. The web serving software may be modified by the addition of the software of the invention as described below. Depending on demands, a load-balancing cluster may be employed rather than a single server. A server or cluster may be provided to provide the functionality of processing client requests and rewriting third party content, with a backend database server to collect usage data.

Devices 20 are indicated as handheld devices. Devices 20 may be, for example, WAP enabled cellular telephones, personal digital assistants, or other devices. Devices 20 may be devices having a keyset that is less than one key for each letter of the alphabet. For example, devices 20 may be configured so that each key may represent one of a plurality of characters, depending on the number of times the key is tapped in quick succession. Devices 20 may also use other systems for input of characters.

In FIG. 1, devices 20 communicate with server 10 via a network, which may be the Internet. Devices 20 may communicate over wireless communications links to a cellular tower, and then to an Internet service provider. Devices 20 are preferably not constrained to communicate with the network via server 10. For example, system server 10 is preferably not connected as a proxy server to devices 20.

Foreign servers 30 are network resources which have content that may be displayed on devices 20. For example, foreign servers 30 may be web servers employing a language designed for display on devices having limited screen space, limited memory, limited display capability, and/or connected to the resource over a relatively narrow bandwidth. An example of such a language is wireless markup language (WML). A further example is handheld device markup language (HDML). The foregoing examples are not meant to be exclusive of other languages. Servers 30 communicate with devices 20 and servers 10 over a network, which may be the Internet. In FIG. 1, for clarity of illustration, the Internet is shown twice, to indicate clearly that devices 20 and foreign servers 30 do not communicate directly in the method and system of the invention. Rather, such communications are routed through system server 20.

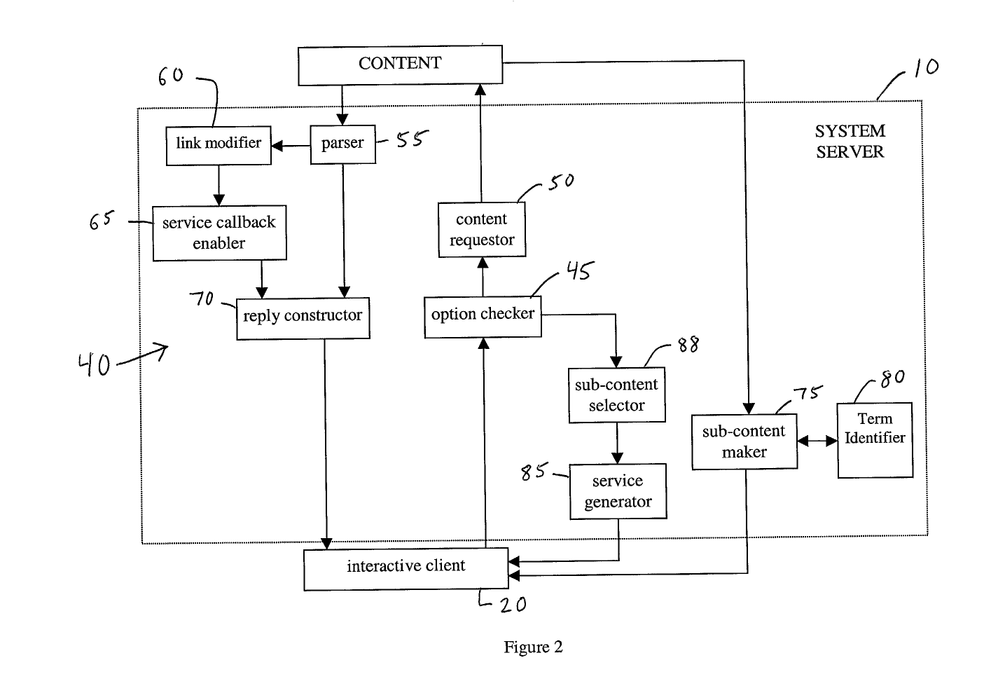

System server 20 and the software running thereon will now be explained with reference to FIG. 2. Software 40 running on server 20 may be implemented in any suitable software language. In one embodiment, the functionality of software 20 may be implemented as a Java servlet. The software may be implemented in other formats, such as CGI scripts. The modules of software 40 include option checker 45, content requestor 50, parser 55, link modifier 60, service callback enabler 65, reply constructor 70, subcontent maker 75, term identifier 80, and service generator 85. Content is obtained over the Internet from a foreign server 30.

Option checker 45 has the function of receiving requests from devices, or clients, such as devices 20, and determining where to route those requests. The request is generated by the user typically by clicking on a hyperlink or virtual button on the screen of the device 20. The request ordinarily contains certain address information, in a suitable format. The request is read by the option checker 45. The option checker 45 assigns the request to one of a number of categories. In one implementation, the categories may be requests for content, requests for sub-content, and requests for interactive content. The option checker 45 then forwards the request to an appropriate module.

Content requester 50 has the function of generating a request for content from a third party server 30. Thus content requestor servers as a means for requesting, in response to a request from a client, a document from a second network resource. The request may be in a suitable format, such as WAP format. The request will specify that the content is to be returned to server 10. Thus the request generated by content requester 50 differs from the request received from device 20 in that the request from device 20 specified that the data be returned to device 20, while the request generated by content requester 50 specifies that the data be returned to server 10. The request is sent over the Internet to foreign server 30. Content requester 50 may also employ a look-up table to identify content that has been cached locally.

The parser 55 has the function of reviewing content received from a third party network resource and determining whether the content is in a format understood by the software system. The content is ordinarily in a format which can be understood, such as WML. If the content is in a format that can be understood, the parser has the function of parsing the code. The parser may allow for modifications of the content after the content has been parsed. Since parsers are well known in the art, the function will not be discussed further here.

Link modifier 60 has the function of rewriting links and other tags in the content. Link modifier 80 serves as a means for identifying and rewriting instructions in a document requested from a second network resource, to request a second document from a location other than the first network resource. The rewriting of links is accomplished by rewriting the URL in the link as a URL that refers to a memory location on server 10. The original address is preferably maintained in the link, so that the address information is provided to server 10 as part of the request from the device. The address information is then available for use by content requestor 50. Any replaced link may be replaced with a token link which is redirected to the original link.

Service callback enabler 65 is a software module that has the purpose of adding to the content a hyperlink which enables the functionality of the system. Service callback enabler 65 serves as means for providing to a user employing a client device a screen portion having a link to linked term content available on the first network resource. The link may be provided at the top or bottom of a page, or at both the top and bottom. Other code may also be added to the content with the same purpose.

Reply constructor 70 is a software module which has the function of constructing a reply to the interactive client's request. Reply constructor 70 preferably provides content that appears to the user to be in the same document format as if the method of the invention had not been used. Reply constructor 70 servers as a means for providing a document with rewritten instructions to a client.

Subcontent maker 75 has the function of concatenating sequential terms in the content that have been designated in a database as phrases. A system administrator may select phrases to designate. In the example below, the phrase “cellular telephone” is recognized as a phrase.

Term identifier 80 has the function of identifying terms in the content with which links will be associated. Term identifier 80 may use a database of terms that have links associated therewith. The terms include individual words, phrases made up of more than one word, telephone numbers, dates, and other sequences of characters that may be designated. A database may be used for this purpose. Service generator 80 generates content with links to various services based on the selected word or phrase. The services, explained below, may include providing news, searching the Internet, shopping, stock quotes, and other services.

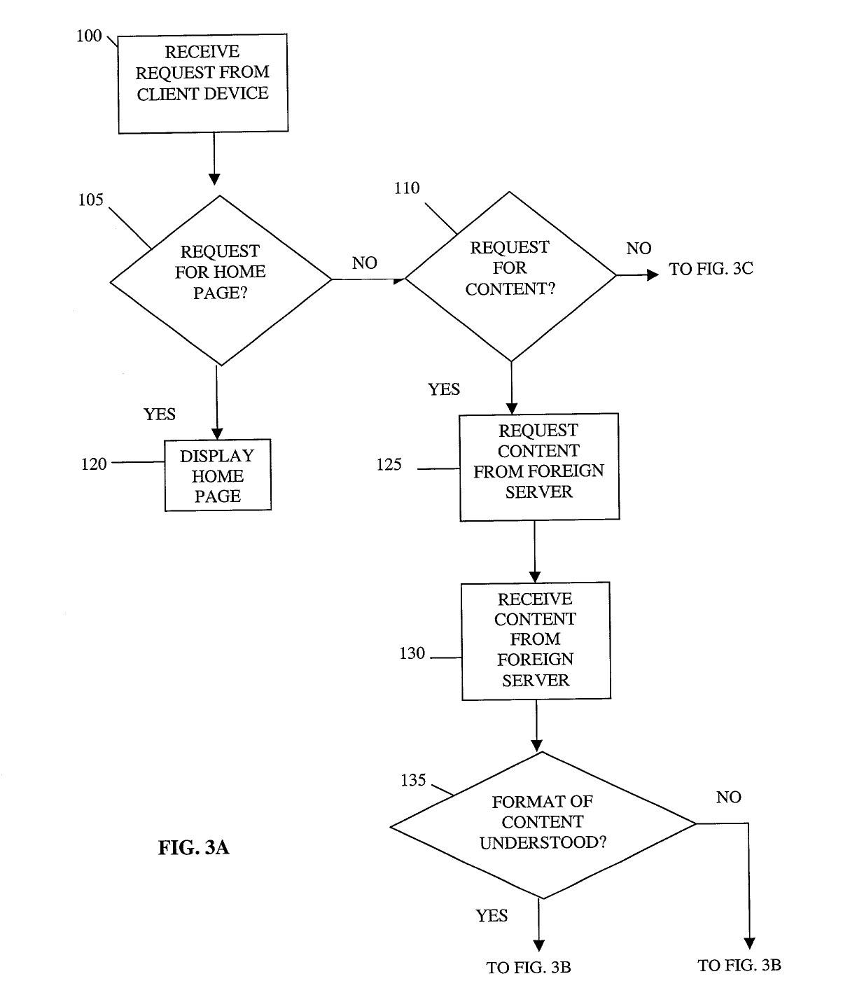

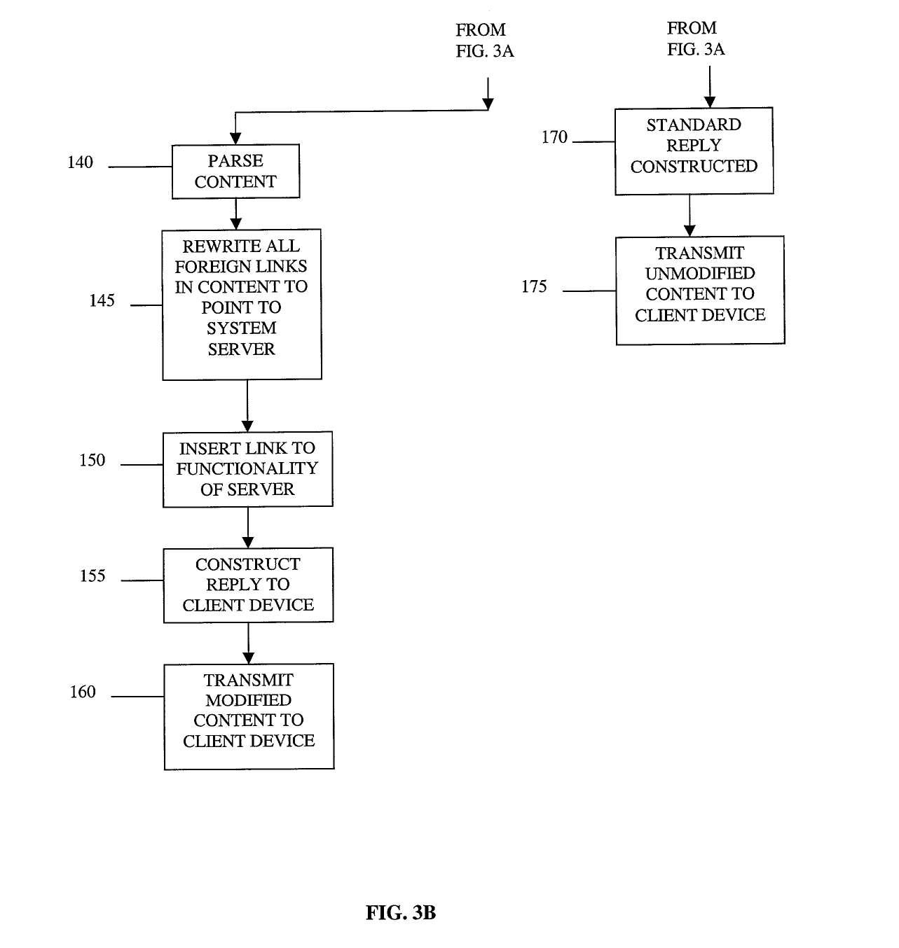

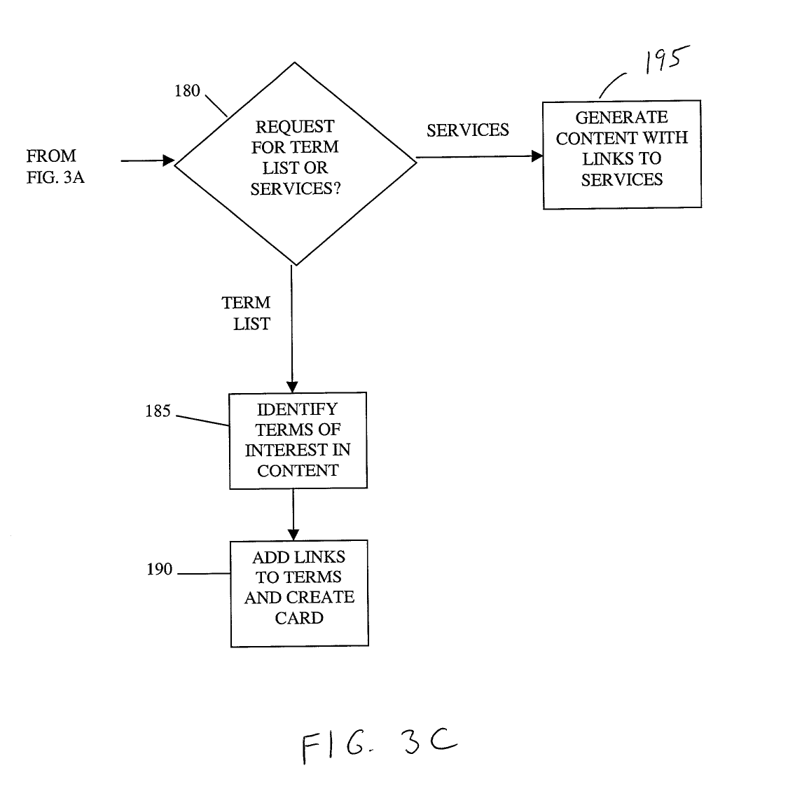

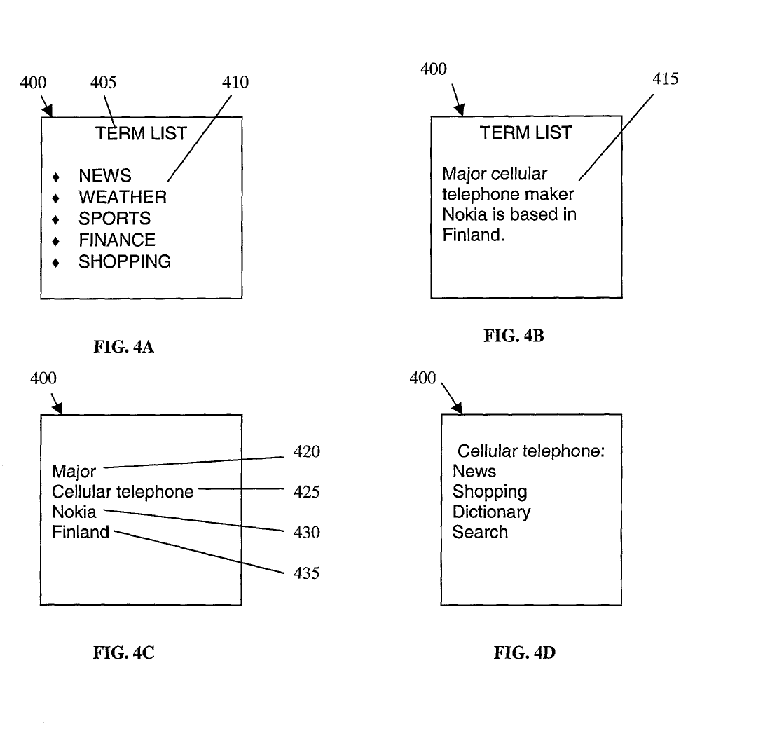

A process flow in accordance with the invention will now be explained with reference to FIGS. 3A, 3B and 3C. The process commences with the step of receiving a request from a client device, as indicated by block 100 in FIG. 3A. The request is ordinarily received over a network, such as the Internet. Customarily, the server of the invention will not be configured as a proxy server with respect to the client device. The request is classified by software running on server 10. Classification decisions are indicated at blocks 105, 110, and 115. The sequence of decisions is merely for convenience of illustration, and may be altered as desired. If the request is from a device seeking content hosted on server 10, such as a device seeking a home page at startup, the page is displayed, as indicated by block 120. The page includes, in a neutral area of the screen, a link to activate the functionality of the system. This link may be added by service callback enabler 65. An example is shown in FIG. 4. Exemplary display 400 is an exemplary home page. A separate button 405, labeled “SERVICES”, is inserted at the top of the page by server 10. The function of this button is explained below. A list of typical options is provided at 410. Clicking on any of these will result in being presented with, for example, a list of links to network resources providing the type of information described, such as news, weather, sports, finance and shopping. The network resources may be third party network resources, such as websites hosted on servers 30 of FIG. 1. However, the links in the page displayed in FIG. 4 are ordinarily to additional content hosted on server 10, and not to the third party resource.

If, in the process flow of FIG. 3, the request was for content hosted at a foreign server, then server 10 requests the content from the foreign server, as indicated by decision block 110 and block 125. The content from the foreign server is received by server 10, as indicated by block 130. The system determines if the content from the foreign server is in a format understood by the software of server 10, as indicated by block 135. As noted above, this step may be carried out by the parser. Typically, the content will be in the form of WML source code, which would be understood.

Referring now to FIG. 3B, if the content from the foreign server is in a format understood by the software, then the content is parsed, as indicated by block 140. Parsing of content is well known in the field, and will not be further explained here. After the content has been parsed, all links to resources other than those on the system server 10 are identified and rewritten to constitute links to an address on server 10, as indicated by block 145. All links preferably continue to have the information to point to the foreign server, so that the system will be able to retrieve the content identified by the link upon request from the client device. The links may be replaced with a token link. Preferably, all content is cached at this point on a server available to server 10 over a high-speed line, such as a local server. A database may be employed to record the address at which the content is cached. Future requests from client devices for the same content may be fulfilled by retrieving the cached content. This step reduces server load, as the steps of parsing and rewriting need not be repeated. Also, bandwidth of the connection of server 10 to the Internet or other network is conserved. It will be appreciated that an expiration time for the cached pages may be selected by an administrator. If possible, the software may attempt to verify that the source page at the foreign server has not been changed since the cached content was created.

The system of the invention, under direction of the software of the invention, then inserts into the modified content the portion of the screen that enables the device to access features made available by the server. This step is indicated by block 150. The system then constructs a reply to the request received from the client device, as indicated by block 155. The system then transmits the reply, containing the modified content, to the client device, as indicated by block 160. Transmission to the client device 20 of FIG. 1 is via the Internet or other network.. The client device displays the modified content. However, other than the addition of the link to permit access to the additional functionality of the system server, there is preferably no change in the content visible to the user. The substitution of different links is in code which is not visible to the user, and preferably, there is no change in document formatting. It should be noted that it is possible to implement the method of the invention with a change in document formatting; however, this is not preferred.

If the format of the content was not understood, as indicated by a NO reply to the decision block at 135 in FIG. 3A, then the content is passed through to the client device without parsing or modification. A standard form of reply is constructed, as indicated by block 170 in FIG. 3B. The unmodified content is transmitted, over the Internet or other network, to the client device, as indicated by block 175. Content that does not contain hyperlinks, such as images, would ordinarily be passed through without modification.

The process flow commencing with a request for something other than content from a foreign website will now be explained. This process flow commences on FIG. 3A with a NO response to the decision indicated by block 110. Referring to FIG. 3C, there are two further types of material, other than foreign content, which may be requested in this embodiment. As indicated by decision block 180, those are a term list and services. The term list is a dynamic page based on content that has been transmitted to the client device. It may also be referred to as linked term content. The term list is generated by subcontent maker 75, which searches the content for words, phrases, and other terms which are maintained in a database. When a match is found, the term is included in the term list or linked term content.

An example from the user's perspective is provided at FIG. 4B. Screen 400 is shown as at FIG. 4A, but with content 415 in the form of text. Content 415 will be assumed for this example to have been obtained from foreign network resource 30, and to have been rewritten by server 10 in accordance with the invention. Content 415 appears with the same format as it would without having been rewritten by software on server 10. However, any links behind content 415 have been rewritten. The option TERM LIST has been added to the top of the page. If the user selects TERM LIST, the device sends a request to server 20 for a term list.

If the request is identified as a request for a term list, the software of the invention identifies terms in the content for selection for use in the term list, as indicated by block 185. The database may include words of interest, and phrases of interest. Algorithms for identification of telephone numbers, addresses, and other items of interest may be included. A link is provided for each identified term, as indicated by block 190, and a page is written to the device, as indicated by block 195. An exemplary page is shown at FIG. 4C. Terms 420, 425, 430, 435 are each associated with links. By moving a cursor to any of these terms, and simply clicking, the user transmits a request for services to server 10. As indicated by block 195, a page with links to various services is provided. The services are labeled by category, as indicated in FIG. 4D. For example, for the term “cellular telephones,” links for four exemplary categories are provided. Each of these categories may link to a particular foreign website, to a service on the same site, or to a menu of sites. The link under News may return a dynamically-generated list of recent news articles concerning cellular telephones. The link for Shopping may lead to a dynamically generated list of cellular telephones for purchase, or to a page at a retailer of cellular telephones. The link for Dictionary may result in the user receiving a text definition of the term cellular telephone. These principles may be applied to other products and terms, of course. The categories may vary as well. For example, for “Nokia,” the categories may include Stocks, News, and Search. The Stocks link may result in the user being presented with a web page from a financial services site with information on the company's stock. The Search function may cause a search to be conducted for Internet sites having reference to the search term, with a dynamic page, with a list of links responsive to the search, transmitted to the client device and displayed. For locations, like “Finland,” the categories may include Travel, Weather, and News. Other services may be developed as desired. Any hyperlink in content from foreign websites returned as a result of the foregoing process would be rewritten in accordance with the method of the invention.

It will be understood that certain terms do not appear on the term list. For example, common words such as “a” and “the” would not appear.

Various modifications are possible. For example, a single page could provide the terms, with one or more links appearing in proximity to the terms. Thus, the term “cellular telephone” could appear on a line, with the terms “news” “search,” “shopping” and “dictionary” on lines below. Immediately below the last of those terms, the next identified term, with its associated links, could appear.

The method of the invention may be implemented in any suitable software language. Processes described as implemented in software may be implemented in hardware.

While the invention has been described with respect to particular embodiments, those of ordinary skill in the art will appreciate variations in the method, software, and components that are within the scope and spirit of the invention.

What is claimed is:

1. A method for providing for a first network resource to facilitate access of a client to content, comprising the steps of:
receiving from a user a request for a document stored at a second network resource;
obtaining the requested document from the second network resource;
determining whether the requested document contains instructions for redirecting to a document at a network resource other than said second network resource;
replacing said instructions with an instruction to redirect to said network resource, and providing said document to said user with said replaced instructions.

2. The method of claim 1, comprising the step of providing to the user with said document a screen portion having a link to linked term content on said network resource.

3. The method of claim 2, further comprising the steps of receiving from the user a request for said linked term content, and providing to the user linked term content comprising terms selected from said document, and custom links associated with each of said terms.

4. The method of claim 3, wherein said custom links comprise at least one link for performing a search for documents related to the associated term and providing a document including results of said search to the user.

5. The method of claim 3, wherein said custom links comprise at least one link for providing information relating to availability of products and services associated with said term.

6. The method of claim 3, wherein said step of providing comprises use of wireless access protocol.

7. A system for providing for a first network resource to facilitate access of a client to content, comprising:
means for requesting, in response to a request from a client, a document from a second network resource;
means for identifying and rewriting instructions in said document to request a second document from a location other than on said first network resource; and
means for providing said document to said client with said rewritten instructions.

8. The system of claim 7, wherein said system further comprises means for providing to the user with said document a screen portion having a link to linked term content available on said first network resource.

9. The system of claim 8, further comprising means for providing to the user, in response to a request for said linked term content, linked term content comprising terms selected from said document, and custom links associated with each of said terms.

10. The system of claim 9, wherein said custom links comprise at least one link for performing a search for documents related to the associated term and providing a document including results of said search to the user.

11. The system of claim 9, wherein said custom links comprise at least one link for providing information relating to availability of products and services associated with said term.

12. The system of claim 7, wherein said means for providing comprises means for using of wireless access protocol.

13. A storage medium having stored therein a plurality of instructions, wherein the plurality of instructions, when executed by a processor at a first network resource, cause the processor to perform the steps of:
receiving from a user a request for a document stored at a second network resource;
obtaining the requested document from the second network resource;
determining whether the requested document contains instructions for redirecting to a document at a network resource other than said second network resource;
replacing said instructions with an instruction to redirect to said network resource, and providing said document to said user with said replaced instructions.

14. The storage medium of claim 13, wherein said instructions cause the processor to perform the further step of providing to the user with said document a screen portion having a link to linked term content on said network resource.

15. The storage medium of claim 14, wherein said instructions cause the processor to perform the further steps of receiving from the user a request for said linked term content, and providing to the user linked term content comprising terms selected from said document, and custom links associated with each of said terms.

16. The storage medium of claim 15, wherein said custom links comprise at least one link for performing a search for documents related to the associated term and providing a document including results of said search to the user.

17. The storage medium of claim 15, wherein said custom links comprise at least one link for providing information relating to availability of products and services associated with said term.

18. The storage medium of claim 13, wherein instructions cause said processor, in said step of providing, to se wireless access protocol.
